(19) United States
(12) Patent Application Publication
(10) Pub. No.: US 2026/0269307 A1
(43) Pub. Date: Sep. 10, 2026

(54) POSITIVE ELECTRODE MIXTURE, PRODUCTION METHOD FOR POSITIVE ELECTRODE MIXTURE, AND LITHIUM-ION BATTERY

(71) Applicant: IDEMITSU KOSAN CO.,LTD., Chiyoda-ku, Tokyo (JP)

(72) Inventors: Yamato HANIU, Chiyoda-ku, Tokyo (JP); Yu ISHIHARA, Chiyoda-ku, Tokyo (JP); Yuta FUJII, Chiyoda-ku, Tokyo (JP)

(73) Assignee: IDEMITSU KOSAN CO.,LTD., Chiyoda-ku, Tokyo (JP)

(21) Appl. No.: 19/165,555

(22) PCT Filed: Mar. 12, 2024
(86) PCT No.: PCT/JP2024/009496

§ 371 Date: Sep. 15, 2025

(30) Foreign Application Priority Data
Mar. 16, 2023 (JP) 2023-041901

(51) Int. Cl. H01M 10/0562; H01M 4/02; H01M 4/38; H01M 4/62; H01M 10/0525

(52) U.S. Cl. CPC H01M 10/0562; H01M 4/38; H01M 4/625; H01M 10/0525; H01M 2004/028; H01M 2300/0068

(57) ABSTRACT

There is provided a positive electrode mixture comprising a sulfur-based active material and a sulfide solid electrolyte, wherein the sulfide solid electrolyte contains phosphorus (P) and halogen (X) including at least iodine (I) as constituent elements, and a molar ratio (X/P) of the halogen (X) to the phosphorus (P) is 0.86 or more, and a molar ratio (I/P) of the iodine (I) to the phosphorus (P) is 0.10 or more.

### TECHNICAL FIELD

The present invention relates to a positive electrode mixture, a production method for a positive electrode mixture, and a lithium-ion battery.

### BACKGROUND ART

In a sulfur-based positive electrode mixture used in an all-solid-state lithium-ion battery, it is necessary to form a composite with a conductive aid and a solid electrolyte in order to cause a sufficient reaction of an insulating sulfur-based active material. A production method for a positive electrode mixture by adding a solid electrolyte to a composite material of a sulfur-based active material and a carbon material, mechanically mixing the composite material with strong energy, and heating the composite material is disclosed (Patent Document 1).

### RELATED ART DOCUMENTS

### Patent Documents

[Patent Document 1] Japanese Patent No. 6243103

### SUMMARY OF INVENTION

In the positive electrode mixture described in Patent Document 1, when a composite material of a sulfur-based active material and a carbon material is mechanically mixed with a solid electrolyte to form a composite, the solid electrolyte deteriorates, and lithium ion conductivity decreases. A decrease in lithium-ion conductivity of the solid electrolyte leads to a decrease in rate characteristics of the positive electrode mixture containing the solid electrolyte and the all-solid-state lithium-ion battery.

In order to restore the lithium ion conductivity of the solid electrolyte reduced by mechanical mixing, heat treatment is required. However, this leads to an increase in production costs, such as an increase in the number of steps and an increase in energy consumption. In addition, phenomena such as the outflow of the sulfur-based active material that was formed into a composite with the solid electrolyte by mechanical mixing, and other related issues, can occur.

An object of the present invention is to provide a positive electrode mixture that does not require a heat treatment to restore lithium ion conductivity and can obtain a battery having excellent rate characteristics.

According to the present invention, the following positive electrode mixture and the like are provided.

1. A positive electrode mixture comprising a sulfur-based active material and a sulfide solid electrolyte, wherein
the sulfide solid electrolyte comprises phosphorus (P) and halogen (X) including at least iodine (I) as constituent elements,
a molar ratio (X/P) of the halogen (X) to the phosphorus (P) is 0.86 or more, and
a molar ratio (I/P) of the iodine (I) to the phosphorus (P) is 0.10 or more.

2. The positive electrode mixture according to 1, wherein
the sulfide solid electrolyte comprises lithium (U) as a constituent element, and
a molar ratio (U/P) of the lithium (U) to the phosphorus (P) is 2.00 or more.

3. The positive electrode mixture according to 1 or 2, wherein the sulfur-based active material comprises elemental sulfur or a discharge product thereof.

4. The positive electrode mixture according to any one of 1 to 3, further comprising a conductive aid.

5. The positive electrode mixture according to 4, wherein the conductive aid is activated carbon.

6. The positive electrode mixture according to any one of 1 to 5, wherein a solid electrolyte deterioration parameter Δ (Δ=α×β) calculated from an ion conductivity α of the sulfide solid electrolyte and an ion resistance β of the positive electrode mixture is less than 750.

7. A production method for a positive electrode mixture, comprising a step of mechanically mixing a sulfur-based active material and a sulfide solid electrolyte to form a composite, wherein
the sulfide solid electrolyte is synthesized from a mixed raw material comprising lithium (U), phosphorus (P), and halogen (X) including at least iodine (I), and
when it is assumed that the mixed raw material is a mixture of lithium sulfide (Li₂S), diphosphorus pentasulfide (P₂S₅), and lithium halide (LiX), the formulas (1) and (2) below are satisfied:

$$45 \leq [ {Li}_{2} S ] \times 100 / ( [ {Li}_{2} S ] + [ {P}_{2} {S}_{5} ] ) \leq 90 \qquad ( 1 )$$

$$30 \leq [ L i X ] \times 100 / ( [ L {i}_{2} S ] + [ {P}_{2} {S}_{5} ] + [ L i X ] ) \qquad ( 2 )$$

wherein, in the formulas, [Li₂S] is a molar ratio of Li₂S, [P₂S₅] is a molar ratio of P₂S₅, and [LiX] is a molar ratio of LiX.

8. The production method according to 7, wherein the mixed raw material is a mixture of lithium sulfide (Li₂S), diphosphorus pentasulfide (P₂S₅), and lithium halide (LiX).

9. The production method according to 7 or 8, wherein the formula (1) [Li₂S]×100/([Li₂S]+[P₂S₅]) is 74 or more and 76 or less.

10. The production method according to any one of 7 to 9, wherein the sulfur-based active material comprises elemental sulfur or a discharge product thereof.

11. The production method according to any one of 7 to 10, wherein a sulfur-based active material-conductive aid composite material is formed from the sulfur-based active material and the conductive aid, and then mechanically mixed with the sulfide solid electrolyte.

12. A positive electrode mixture obtained by the production method according to any one of 7 to 11.

13. A positive electrode comprising the positive electrode mixture according to any one of 1 to 6 and 12.

14. A lithium-ion battery comprising the positive electrode according to 13.

According to the present invention, it is possible to provide a positive electrode mixture that does not require a heat treatment to restore lithium ion conductivity and can obtain a battery having excellent rate characteristics.

### MODE FOR CARRYING OUT THE INVENTION

Hereinafter, embodiments of the present invention will be described. In the present specification, the numerical values of the upper limit and the lower limit regarding the numerical ranges of “equal to or more than”, “equal to or less than”, and “to” are numerical values that can be combined in any manner, and the numerical values of Examples can also be used as the numerical values of the upper limit and the lower limit.

### 1. Positive Electrode Mixture

A positive electrode mixture according to one embodiment of the present invention comprises a sulfur-based active material and a sulfide solid electrolyte. In addition, the sulfide solid electrolyte contains phosphorus (P) and halogen (X) including at least iodine (I) as constituent elements, and a molar ratio (X/P) of the halogen (X) to the phosphorus (P) is 0.86 or more, and a molar ratio (I/P) of the iodine (I) to the phosphorus (P) is 0.10 or more.

In the positive electrode mixture of the present embodiment, the sulfide solid electrolyte exhibits sufficiently high lithium ion conductivity, and deterioration of the sulfide solid electrolyte is suppressed even after mechanical mixing as compared with the conventional positive electrode mixture. This eliminates the need for heat treatment for restoring lithium ion conductivity. In addition, a lithium-ion battery having rate characteristics equal to or higher than those in the case of using a conventional positive electrode mixture can be obtained.

Hereinafter, the components of the present embodiment will be described.

### (Sulfide Solid Electrolyte)

The sulfide solid electrolyte used in the present application contains a predetermined amount of halogen (X) including at least iodine (I). The sulfide solid electrolyte is less deteriorated by mechanical mixing. Therefore, heat treatment for restoring lithium ion conductivity is unnecessary.

In one embodiment, the molar ratio (X/P) is preferably 0.90 to 2.5, more preferably 1.00 to 2.00, and even more preferably 1.05 to 1.80.

Examples of the halogens other than iodine include fluorine, chlorine, and bromine. The halogen (X) may contain only iodine, or may be composed of iodine and one other type of halogen. Preferably, the halogen (X) includes iodine and bromine.

The molar ratio (I/P) is preferably 0.50 to 2.00 and more preferably 1.00 to 1.80.

In one embodiment, the sulfide solid electrolyte is preferably a solid electrolyte containing a glass (amorphous) component. The inclusion of a glass component can be confirmed by the presence of a broad peak (halo pattern) derived from an amorphous component in X-ray diffraction (XRD) measurement. In the XRD measurement of the sulfide solid electrolyte, a peak derived from a crystal component or a peak derived from a raw material may be partially observed.

In one embodiment, the sulfide solid electrolyte preferably contains lithium (Li) as a constituent element. The molar ratio (Li/P) of lithium (Li) to phosphorus (P) is preferably 3.00 to 5.25, more preferably 3.50 to 5.20, still more preferably 4.00 to 5.00, and further preferably 4.00 to 4.80.

In one embodiment, the molar ratio (S/P) of sulfur (S) to phosphorus (P) is preferably 3.0 to 4.4, more preferably 3.5 to 4.3, still more preferably 3.8 to 4.2, and further preferably 3.9 to 4.1.

The type and molar ratio of the constituent elements of the sulfide solid electrolyte can be confirmed by, for example, an ICP emission spectroscopic analyzer.

The molar ratio of the constituent elements of the sulfide solid electrolyte can be adjusted by controlling the blending of raw materials. The molar ratio of the constituent elements in the raw material is substantially equal to the molar ratio of the constituent elements in the sulfide solid electrolyte to be obtained.

In one embodiment, the ion conductivity of the sulfide solid electrolyte to be used is preferably 1.0 mS/cm or more, and more preferably 1.5 mS/cm or more.

The sulfide solid electrolyte used in the present embodiment can be produced, for example, by preparing a starting material of a known lithium-ion sulfide solid electrolyte such that the molar ratio of constituent elements satisfies the above-described range, and mechanically mixing the starting material.

As the starting material, two or more types of compounds or simple substances containing, as constituent elements, lithium, phosphorus, sulfur, and halogen including at least iodine can be used in combination, and any starting material can be employed without particular limitation as long as the starting material exhibits ion conductivity caused by the contained metal atom.

Examples of the raw material containing lithium (U) include lithium compounds such as lithium sulfide (Li₂S), lithium oxide (Li₂O), and lithium carbonate (Li₂CO₃), and a lithium metal simple substance. Among them, a lithium compound is preferable, and lithium sulfide is more preferable.

The lithium sulfide can be used without particular limitation, but a high-purity lithium sulfide is preferable. Lithium sulfide can be produced, for example, by the methods described in JP 7-330312 A, JP 9-283156 A, JP 2010-163356 A, and JP 2011-84438 A.

Specifically, lithium hydroxide and hydrogen sulfide are reacted in a hydrocarbon-based organic solvent at 70° C. to 300° C. to generate lithium hydrosulfide, and this reaction liquid is then subjected to dehydrodesulfurization to synthesize lithium sulfide (JP 2010-163356 A).

In addition, lithium hydroxide and hydrogen sulfide are reacted in an aqueous solvent at 10° C. to 100° C. to generate lithium hydrosulfide, and this reaction liquid is then subjected to dehydrodesulfurization to synthesize lithium sulfide (JP 2011-84438 A).

Examples of the raw material containing phosphorus (P) include phosphorus sulfide such as diphosphorus trisulfide (P₂S₃) and diphosphorus pentasulfide (P₂S₅), phosphorus compounds such as sodium phosphate (Na₃PO₄), and phosphorus simple substance. Among them, phosphorus sulfide is preferable, and diphosphorus pentasulfide (P₂S₅) is more preferable. The phosphorus compound, such as diphosphorus pentasulfide (P₂S₅), and the phosphorus simple substance can be used without particular irritation as long as the phosphorus compound and the phosphorus simple substance are industrially produced and sold.

As a raw material containing a halogen as a constituent element, it is preferable to include, for example, a halogen compound represented by the following formula.

Mₗ-Xₘ

In the formula, M represents sodium (Na), lithium (U), boron (B), aluminum (Al), silicon (Si), phosphorus (P), sulfur (S), germanium (Ge), arsenic (As), selenium (Se), tin (Sn), antimony (Sb), tellurium (Te), lead (Pb), bismuth (Bi), or a combination of these elements with an oxygen element or a sulfur element, lithium (U) or phosphorus (P) is preferable, and lithium (U) is more preferable.

X is a halogen element selected from fluorine (F), chlorine (Cl), bromine (Br), and iodine (I).

In addition, I is an integer of 1 or 2, and m is an integer of 1 to 10. When m is an integer of 2 to 10, that is, when there are a plurality of X's, X may be the same or different. For example, in SiBrCl₃, m is 4, and X is composed of different elements of Br and Cl.

Specific examples of the halogen compound include: sodium halides such as NaI, NaF, NaCl, and NaBr; lithium halides such as LiF, LiCl, LiBr, and LiI; boron halides such as BCl₃, BBr₃, and Bl₃; aluminum halides such as AlF₃, AlBr₃, AlI₃, and AlCl₃; silicon halides such as SiF₄, SiCl₄, SiCl₂, Si₂Cl₆, SiBr₄, SiBrCl₃, SiBr₂Cl₂, and SiI₄; phosphorus halide such as PF₃, PF₅, PCl₃, PCl₅, POCl₃, PBr₃, POBr₃, PI₃, P₂Cl₄, and P₂I₄; sulfur halides such as SF₂, SF₄, SF₆, S₂F₁₀, SCl₂, S₂Cl₂, and S₂Br₂; germanium halides such as GeF₄, GeCl₄, GeBr₄, GeI₄, GeF₂, GeCl₂, GeBr₂, and GeI₂; arsenic halides such as AsF₃, AsCl₃, AsBr₃, AsI₃, and AsF₅; selenium halides such as SeF₄, SeFe₆, SeCl₂, SeCl₄, Se₂Br₂, and SeBr₄; tin halides such as SnF₄, SnCl₄, SnBr₄, SnI₄, SnF₂, SnCl₂, SnBr₂, or SnI₂; antimony halide such as SbF₃, SbCl₃, SbBr₃, SbI₃, SbF₅, or SbCl₅; tellurium halides such as TeF₄, Te₂F₁₀, TeF₆, TeCl₂, TeCl₄, TeBr₂, TeBr₄, and TeI₄; lead halides such as PbF₄, PbCl₄, PbF₂, PbCl₂, PbBr₂, and PbI₂; and bismuth halides such as BiF₃, BiCl₃, BiBr₃, and BiI₃.

Among them, lithium halides such as lithium chloride (LiC), lithium bromide (LiBr), and lithium iodide (LiI), and phosphorus halides such as phosphorus pentachloride (PCl₅), phosphorus trichloride (PCl₃), phosphorus pentabromide (PBr₅), and phosphorus tribromide (PBr₃) are preferable, lithium halides such as LiCl, LiBr, and LiI, and PBr₃ are more preferable, lithium halides such as LiCl, LiBr, and LiI are still more preferable, and LiI and LiBr are particularly preferable.

As the halogen compound, a compound containing iodine among the above-described compounds may be used alone or in combination with two or more types thereof.

In one embodiment, when it is assumed that the mixed raw material is a mixture of lithium sulfide (Li₂S), diphosphorus pentasulfide (P₂S₅), and lithium halide (LiX), the following formulas (1) and (2) are satisfied.

$$45 \leq [ {Li}_{2} S ] \times 100 / ( [ {Li}_{2} S ] + [ {P}_{2} {S}_{5} ] ) \leq 90 \qquad ( 1 )$$

$$30 \leq [ L i X ] \times 100 / ( [ L {i}_{2} S ] + [ {P}_{2} {S}_{5} ] + [ L i X ] ) \qquad ( 2 )$$

In the formulas, [Li₂S] is a molar ratio of Li₂S, [P₂S₅] is a molar ratio of P₂S₅, and [LiX] is a molar ratio of LiX.

The formula (1) [Li₂S]×100/([Li₂S]+[P₂S₅]) is preferably 70 or more and 80 or less, more preferably 72 or more and 78 or less, and particularly preferably 74 or more and 76 or less. The formula (2) [LiX]×100/([Li₂S]+[P₂S₅]+[LiX]) is preferably 30 or more and 60 or less, and more preferably 35 or more and 55 or less.

In one embodiment, the mixed raw material of the sulfide solid electrolyte is a mixture of lithium sulfide (Li₂S), diphosphorus pentasulfide (P₂S₅), lithium iodide (LiI), and any lithium halide (LiX: X is F, Cl, or Br). The molar ratio (I/P) of iodine (I) to phosphorus (P) is preferably 0.10 or more.

In the present embodiment, a mechanical stress is applied to the above-described raw material to react the raw material to obtain a sulfide solid electrolyte. Here, “applying mechanical stress” means applying mechanical shear force, impact force, or similar mechanical forces. Examples of the means for applying the mechanical stress include a pulverizer such as a planetary ball mill, a vibration mill, or a rolling mill, and a kneader. By strong mechanical stress, at least a part of the raw material powders is ground and mixed until crystallinity cannot be maintained.

As conditions for pulverizing and mixing, for example, when a planetary ball mill is used as a pulverizer, the treatment may be performed for 0.5 hours to 100 hours at a rotation speed of several tens to several hundreds of revolutions/min. More specifically, in the case of the planetary ball mill (manufactured by Fritsch, model number P-7) used in Examples of the present application, the rotation speed of the planetary ball mill is preferably 100 rpm or more and 500 rpm or less, and more preferably 150 rpm or more and 400 rpm or less. The temperature during pulverizing may be room temperature, and in this case, cooling from the outside is not performed, and for example, an operation suspension period of 5 minutes may be provided every hour. Note that the pulverizing may be performed while cooling without providing an operation suspension period as long as the pulverizing is not accompanied by crystallization.

When, for example, a zirconia ball is used as the pulverizing medium, the diameter of the ball is preferably 0.2 to 20 mm.

### (Sulfur-Based Active Material)

The sulfur-based active material is not particularly limited, and examples thereof include sulfur, lithium sulfide (Li₂S), lithium polysulfide (Li₂Sₙ: n satisfies 1<n≤8.), titanium sulfide (TiS₂), molybdenum sulfide (MoS₂), iron sulfide (FeS, FeS₂), copper sulfide (CuS), nickel sulfide (Ni₃S₂), and sulfur-containing polymer compounds.

Sulfur is not particularly limited, but sulfur having a high purity is preferable. Specifically, the purity is preferably 95 mass % or more, more preferably 96 mass % or more, and particularly preferably 97 mass % or more.

Examples of the crystal system of sulfur include α-sulfur (orthorhombic system), β (monoclinic system), γ (monoclinic system), and amorphous sulfur. These can be used alone or in combination with two or more types thereof.

Incidentally, a part or all of the elemental sulfur is changed to a discharge product during the battery reaction. Therefore, in the positive electrode mixture (positive electrode) of one embodiment, a discharge product of elemental sulfur exists.

Examples of the discharge product of elemental sulfur include Li₂S in a completely discharged state and Li₂S₂, Li₂S₄, Li₂S₆, Li₂S₈ and the like as lithium polysulfide in the middle stage thereof.

### (Conductive Aid)

In one embodiment of the present invention, the positive electrode mixture preferably further contains a conductive aid.

The conductive aid may be any material having electron conductivity. The conductive aid preferably has a plurality of pores. A carbon material having pores is particularly preferable. Since the carbon material has high conductivity and is lighter than other conductive materials, the power density and capacity per weight of the battery can be increased.

The specific surface area of the conductive aid is preferably 0.1 m²/g or more and 5,000 m²/g or less, more preferably 1 m²/g or more and 4,000 m²/g or less, still more preferably 1 m²/g or more and 3,000 m²/g or less, and most preferably 10 m²/g or more and 3,000 m²/g or less.

The pore volume of the conductive aid is preferably 0.1 cc/g or more and 5.0 cc/g or less.

The pores of the conductive aid preferably have an average diameter of 0.1 nm or more and 40 nm or less, more preferably 0.5 nm or more and 40 nm or less, still more preferably 0.5 nm or more and 20 nm or less, and most preferably i nm or more and 20 nm or less.

The specific surface area, the pore volume, and the pore diameter of the conductive aid can be determined using a nitrogen adsorption isotherm obtained by adsorbing nitrogen gas to the conductive aid at a liquid nitrogen temperature. Specifically, the specific surface area can be calculated by the Brunauer-Emmett-Teller (BET) multipoint method using a nitrogen adsorption isotherm. The pore volume and the pore diameter can be determined by the Barrett-Joyner-Halenda (BJH) method using a nitrogen adsorption isotherm.

As the manufactured, for example, a specific surface area/pore distribution measurement apparatus (Autosorb-3) manufactured by Quantachrome Instruments can be used for the measurement.

The carbon material is not particularly limited, and examples thereof include carbon blacks such as Ketjen black, acetylene black, Denka black, thermal black and channel black, mesoporous carbon, activated carbon, amorphous carbon, carbon nanotubes, vapor grown carbon fiber (VGCF), and carbon nanohom. Examples of the conductive carbon material include fullerene, carbon fiber, natural graphite, artificial graphite, graphene, graphene oxide, and reduced graphene oxide. Among them, activated carbon is preferable. In addition, these may be used alone or in combination with two or more types thereof. These composite materials can also be used.

In one embodiment, the positive electrode mixture may or may not contain other components in addition to the sulfur-based active material, the sulfide solid electrolyte, and the conductive aid.

The other components are not particularly limited, and examples thereof include a binder, a solvent, and a dispersant.

In one embodiment, a solid electrolyte deterioration parameter Δ(Δ=α×β) calculated from an ion conductivity α of the sulfide solid electrolyte and an ion resistance β of the positive electrode mixture is less than 750.

The larger the solid electrolyte deterioration parameter Δ is, the lower the retention rate of the ion conductivity of the solid electrolyte is. That is, it indicates that the degree of deterioration of the solid electrolyte generated at the time of producing the positive electrode mixture is large.

In the present invention, when the solid electrolyte deterioration parameter Δ of the positive electrode mixture is 750 or more, it is evaluated that the solid electrolyte has deteriorated. The solid electrolyte deterioration parameter Δ is preferably 600 or less, more preferably 500 or less, and still more preferably 250 or less.

The ion conductivity α of the sulfide solid electrolyte can be measured by an AC impedance method. Details of the measurement method will be described later.

The ion resistance β of the positive electrode mixture can be measured by preparing an ion resistance measurement cell containing the positive electrode mixture and a solid electrolyte and applying an AC impedance method to the ion resistance measurement cell. Details of the measurement method will be described later.

The positive electrode mixture according to the present embodiment can be produced, for example, by a method described below.

### 2. Production Method for Positive Electrode Mixture

A production method for a positive electrode mixture according to one embodiment of the present invention includes a step of mechanically mixing and compositing the sulfur-based active material described above and a sulfide solid electrolyte satisfying the compositions represented by the formulas (1) and (2) described above.

In one embodiment, a sulfur-based active material-conductive aid composite material may be formed from the sulfur-based active material and the conductive aid described above, and then the sulfide solid electrolyte and the sulfur-based active material-conductive aid composite material may be mechanically mixed.

When the sulfur-based active material is elemental sulfur, in the step of forming a sulfur-conductive aid composite material, for example, the above-described conductive aid and elemental sulfur are mixed and sealed, and then the mixture is heated to melt the elemental sulfur, and the pores are impregnated with the elemental sulfur, thereby forming a sulfur-conductive aid composite material.

The mixing ratio of the elemental sulfur and the conductive aid can be appropriately adjusted according to the material to be used. For example, the mass ratio (S/C) of the elemental sulfur (S) to the conductive aid (C) in the sulfur-based active material-conductive aid composite material is 0.5 or more. Assuming the utilization factor of sulfur remains constant, increasing the ratio of elemental sulfur in the positive electrode mixture is expected to improve the energy density of the battery. On the other hand, since it becomes difficult to sufficiently impart electron conductivity in the positive electrode, the mass ratio (S/C) is preferably 10 or less.

In one embodiment, the mixture of elemental sulfur and the conductive aid is heated in a sealed state at a temperature equal to or higher than the melting point (about 115° C.) of elemental sulfur. The heating temperature is adjusted according to the carbon material and elemental sulfur, and is preferably 130° C. or higher, and more preferably 150° C. or higher. The upper limit of the heating temperature is a temperature equal to or lower than the boiling point (about 445° C.) of elemental sulfur. The heating time is preferably 0.1 to 24 hours.

By cooling after heating, a sulfur-conductive aid composite material is obtained. The pulverizing step may be performed after cooling as necessary.

In the present embodiment, a sulfur-based active material or a sulfur-based active material-conductive aid composite material and a sulfide solid electrolyte are mechanically mixed to form a positive electrode mixture. Here, “mechanical mixing” means applying mechanical shear force, impact force, or similar mechanical forces. Examples of mechanical mixing means include a pulverizer, such as a planetary ball mill, a vibration mill, or a rolling mill, and a kneader.

Through this step, a part of the sulfur-based active material, the sulfur-based active material-conductive aid composite material, and the sulfide solid electrolyte may be pulverized.

For example, in the case of the planetary ball mill (manufactured by Fritsch, model number P-7), the rotation speed of the planetary ball mill is preferably 100 rpm or more and 500 rpm or less, and more preferably 150 rpm or more and 400 rpm or less.

When, for example, a zirconia ball is used as the pulverizing medium, the diameter of the ball is preferably 0.2 to 20 mm.

The content of the sulfide solid electrolyte is preferably 5 to 200 parts by mass, and more preferably 10 to 120 parts by mass when the sulfur-based active material or the sulfur-based active material-conductive aid composite material is regarded as 100 parts by mass. When the content of the solid electrolyte is 5 parts by mass or less, it is difficult to sufficiently obtain ion conductivity, and when the content of the solid electrolyte is 200 parts by mass or more, the content of the active material decreases, and it is difficult to improve the energy density.

### 3. Positive Electrode and Lithium-Ion Battery

A positive electrode or a lithium-ion battery according to one embodiment of the present invention includes the above-described positive electrode mixture of the present invention. For example, an all-solid-state lithium-ion battery can be produced by using a solid electrolyte instead of a liquid electrolyte. By using the positive electrode mixture of the present invention, an all-solid-state lithium-ion battery having good rate characteristics can be prepared.

The all-solid-state lithium-ion battery mainly includes a positive electrode layer, a negative electrode layer, and an electrolyte layer, but the positive electrode mixture of the present invention is suitable as a constituent material of the positive electrode layer. The negative electrode layer and the electrolyte layer can be produced by a known method. In addition to the positive electrode layer, the negative electrode layer, and the electrolyte layer, a current collector is preferably used, and a known current collector is also used.

The solid electrolyte is not particularly limited, and a known solid electrolyte can be used.

### EXAMPLES

Hereinafter, the present invention will be specifically described based on Examples. The embodiments of the present invention are not limited to the examples.

### Example 1

### (1) Preparation of Sulfur-Based Active Material-Conductive Aid Composite Material

Activated carbon (MSC-30 produced by Kansai Thermal Chemical Co., Ltd.) and sulfur were put in a glass bottle at a mass ratio of 3:7, and sealed in a SUS tube container. A sulfur-based active material-conductive aid composite material containing activated carbon and sulfur was obtained by heating at 150° C. for 6 hours and then at 300° C. for 2.75 hours in an electric furnace.

### (2) Preparation of Sulfide Solid Electrolyte

0.2309 g of lithium sulfide, 0.3719 g of diphosphorus pentasulfide, and 0.5972 g of lithium iodide were used as raw materials. The mixed raw material and 10 zirconia balls having a diameter of 10 mm were charged into a 45 mL zirconia pot and sealed. A sulfide solid electrolyte was obtained by mixing at a rotation speed of 370 rpm for 40 hours using a planetary ball mill (manufactured by Fritsch, model number P-7).

### (3) Preparation of Positive Electrode Mixture

0.45 g of the sulfur-based active material-conductive aid composite material and 0.45 g of the above-described sulfide solid electrolyte were charged together with 10 zirconia balls having a diameter of 10 mm in a 45 mL zirconia pot, and the pot was sealed. Mixing was performed for 20 hours under conditions of a rotation speed of 370 rpm and room temperature using a planetary ball mill (manufactured by Fritsch, model number P-7) to obtain a positive electrode mixture.

### Example 2

A positive electrode mixture was obtained in the same manner as in Example 1 except that 0.2553 g of lithium sulfide, 0.4112 g of diphosphorus pentasulfide, and 0.5334 g of lithium iodide were used as raw materials in the production of the sulfide solid electrolyte of Example 1 (2).

### Example 3

A positive electrode mixture was obtained in the same manner as in Example 1 except that 0.2360 g of lithium sulfide, 0.3802 g of diphosphorus pentasulfide, 0.5342 g of lithium iodide, and 0.0495 g of lithium bromide were used as raw materials in the production of the sulfide solid electrolyte of Example 1 (2).

### Comparative Example 1

A positive electrode mixture was obtained in the same manner as in Example 1, except that a sulfide solid electrolyte prepared by the following production method was used.

0.4127 g of lithium sulfide, 0.6655 g of diphosphorus pentasulfide, 0.2137 g of lithium iodide, and 0.2080 g of lithium bromide were used as raw materials. The mixed raw material and 10 zirconia balls having a diameter of 10 mm were charged into a 45 mL zirconia pot and sealed. Mixing was performed at a rotation speed of 370 rpm for 40 hours using a planetary ball mill (manufactured by Fritsch, model number P-7) to obtain a glassy treated product. The treated product was heated at 195° C. for 3 hours to prepare a sulfide sold electrolyte.

### Comparative Example 2

A positive electrode mixture was obtained in the same manner as in Example 1, except that a sulfide solid electrolyte prepared by the following production method was used.

0.3830 g of lithium sulfide and 0.6170 g of diphosphorus pentasulfide were used as raw materials. The mixed raw material and 10 zirconia balls having a diameter of 10 mm were charged into a 45 mL zirconia pot and sealed. Mixing treatment was performed at a rotation speed of 370 rpm for 40 hours using a planetary ball mill (manufactured by Fritsch, model number P-7).

0.8053 g of the obtained treated product, 0.1947 g of lithium borohydride, and 100 g of zirconia balls having a diameter of 4 mm were charged into a 45 mL zirconia pot, sealed, and mixed at a rotation speed of 510 rpm for 15 hours using a planetary ball mill to obtain a sulfide solid electrolyte.

### Comparative Example 3

A positive electrode mixture was obtained in the same manner as in Example 1, except that a sulfide solid electrolyte prepared by the following production method was used.

0.4129 g of lithium sulfide, 0.5875 g of diphosphorus pentasulfide, 0.2241 g of lithium chloride, and 0.2755 g of lithium bromide were used as raw materials. The mixed raw material and 10 zirconia balls having a diameter of 10 mm were charged into a 45 mL zirconia pot and sealed. Mixing treatment was performed at a rotation speed of 370 rpm for 40 hours using a planetary ball mill (manufactured by Fritsch, model number P-7).

The treated product was heated at 430° C. for 8 hours to obtain a sulfide solid electrolyte.

### Comparative Example 4

A positive electrode mixture was obtained in the same manner as in Example 1, except that a sulfide solid electrolyte prepared by the following production method was used.

0.3830 g of lithium sulfide and 0.6170 g of diphosphorus pentasulfide were used as raw materials. The mixed raw material and 10 zirconia balls having a diameter of 10 mm were charged into a 45 mL zirconia pot and sealed. Mixing treatment was performed at a rotation speed of 370 rpm for 40 hours using a planetary ball mill (manufactured by Fritsch, model number P-7).

0.8936 g of the obtained treated product, 0.1064 g of lithium borohydride, and 100 g of zirconia balls having a diameter of 4 mm were charged into a 45 mL zirconia pot, sealed, and mixed at a rotation speed of 370 rpm for 15 hours using a planetary ball mill to obtain a sulfide solid electrolyte.

The method for evaluating the sulfide solid electrolyte prepared in each example is as follows.

### (1) Ion Conductivity of Solid Electrolyte

A circular pellet having a diameter of 10 mm (cross-sectional area S: 0.785 cm²) and a height (L) of 0.1 to 0.5 cm was molded from the solid electrolyte to obtain a sample. The electrode terminals were taken from above and below the sample, and measured at 25° C. by an AC impedance method (frequency range: 1 MHz to 1 Hz, amplitude: 10 mV) to obtain a Cole-Cole plot. The real part Z′ (Ω) at a point where −Z″ (Ω) was minimum near the right end of the arc observed in the high frequency side region was defined as the bulk resistance R (Ω) of the electrolyte, and the ion conductivity σ (S/cm) was calculated according to the following equation.

$$R = ρ ( L / S )$$

$$σ = 1 / ρ$$

### (2) Ion Resistance of Positive Electrode Mixture

### Preparation of Solid Electrolyte A

0.4127 g of lithium sulfide, 0.6655 g of diphosphorus pentasulfide, 0.2137 g of lithium iodide, 0.2080 g of lithium bromide, and 10 zirconia balls having a diameter of 10 mm were charged into a 45 mL zirconia pot, and the pot was sealed. Mixing (mechanical milling) was performed at a rotation speed of 370 rpm for 40 hours using a planetary ball mill (manufactured by Fritsch, model number P-7) to obtain a powder. The obtained powder was heated at 195° C. for 3 hours to obtain a solid electrolyte A.

### Preparation of Ion Resistance Measurement Cell

100 mg of the solid electrolyte A prepared by the above procedure was pressure-molded in a cylinder made of Macor having a diameter of 10 mm. 20 mg of the positive electrode mixture powder was added onto a pressed surface, and the obtained mixture was pressure-molded again. 20 mg of the positive electrode mixture powder was charged onto a pressed surface opposite to the positive electrode mixture, and pressed to prepare an ion resistance measurement cell.

### Ion Resistance Measurement

AC impedance measurement was performed under the following conditions using the ion resistance measurement cell prepared by the above procedure.
Frequency range: 1 MHz to 1 mHz
Amplitude: 10 mV

### (3) Method for Calculating Sold Electrolyte Deterioration Parameter

The solid electrolyte deterioration parameter Δ was obtained by the following calculation.

(Sold electrolyte deterioration parameter Δ)=[Ion conductivity α of solid electrolyte]×[Ion resistance β of positive electrode mixture]

When the sold electrolyte deterioration parameter Δ was 750 or more, it was determined that the solid electrolyte deteriorated.

### (4) Evaluation of Battery Characteristics

In a cylinder made of Macor having a diameter of 10 mm, 100 mg of the solid electrolyte A prepared in the above (2) was pressure-molded. Each positive electrode mixture powder prepared in Examples and Comparative Examples was charged onto the pressed surface such that the amount of sulfur was 1.75 mg, and pressure molding was performed again. Three indium foils and two lithium foils were alternately stacked on a pressed surface opposite to the positive electrode mixture and pressed to prepare an all-solid-state lithium-ion battery.

A constant current charge/discharge test of the obtained battery was performed. The voltage range of the constant current charge and discharge test was set to 0.8 to 2.2 V, and the current value was the condition in Table 1 below. As a discharge capacity (per sulfur mass) at 0.5 C, a value at the 7th cycle under the following conditions was measured.

TABLE 1

Current value [mA]

| Cycle [—] | Discharge | Charge |
|---|---|---|
| 1.2 | 0.147 | 0.147 |
| 3 | 0.147 | 0.293 |
| 4 | 0.293 | 0.293 |
| 5 | 0.586 | 0.293 |
| 6 | 0.977 | 0.293 |
| 7 | 0.147 | 0.293 |

### (5) Properties of Sold Electrolyte

Analysis was performed by powder X-ray diffraction (XRD) measurement. When the spectrum obtained by the following XRD measurement had no peak or had only a peak derived from a raw material, the solid electrolyte was determined to be amorphous. On the other hand, when there was a peak derived from the lithium ion conductive crystal structure, it was determined to be crystalline.

Incidentally, in the sulfide solid electrolyte of Comparative Example 1, a thiolysicon region type II crystal structure was observed, and in the sulfide solid electrolytes of Comparative Examples 2 and 3, an argyrodite type crystal structure was observed.

### XRD Measurement

The powder to be measured was filled in a groove having a diameter of 20 mm and a depth of 0.2 mm, and leveled with glass to obtain a sample. The sample was sealed with Kapton film for XRD and measured without being exposed to air.

The measurement was performed under the following measurement conditions using a powder X-ray diffraction measurement apparatus D2 PHASER manufactured by BRUKER Corporation.

### [Measurement Conditions]

Tube voltage: 30 kV
Tube current: 10 mA
X-ray wavelength: Cu-Kα ray (1.5418 Å)
Optical system: concentration technique
Slit configuration: Solar sit 4° (on both incident side and light receiving side), divergence slit 1 mm, Kβ filter (Ni plate 0.5%), air scatter screen 3 mm is used.
Detector: Semiconductor detector
Measurement range: 26-10 to 60 deg
Step width, scan speed: 0.05 deg, 0.05 deg/see

The raw material composition of the sulfide sold electrolyte is shown in Table 2 for each of the above Examples and Comparative Examples. The results of representing the raw material composition of the sulfide solid electrolyte by the formulas (1) and (2) are shown in Table 3. The molar ratio of the raw material constituent elements to phosphorus (P) is shown in Table 4. The evaluation results of the sulfide solid electrolyte, the positive electrode mixture, and the battery are shown in Table 5.

TABLE 2

| | Molar ratio of raw material mixture | | | | | |
|---|---|---|---|---|---|---|
| | Li₂S | P₂S₅ | LiI | LiBr | LiCl | LiBH₄ |
| Example 1 | 45 | 15 | 40 | 0 | 0 | 0 |
| Example 2 | 48.75 | 16.25 | 35 | 0 | 0 | 0 |
| Example 3 | 45 | 15 | 35 | 5 | 0 | 0 |
| Comp. Ex. 1 | 56.25 | 18.75 | 10 | 15 | 0 | 0 |
| Comp. Ex. 2 | 37.5 | 12.5 | 0 | 0 | 0 | 50 |
| Comp. Ex. 3 | 44.2 | 13.3 | 0 | 15.9 | 26.6 | 0 |
| Comp. Ex. 4 | 50.25 | 16.75 | 0 | 0 | 0 | 33 |

TABLE 3

| | | | | Formula (1) | | Formula (2) |
|---|---|---|---|---|---|---|
| | Molar ratio Li₂S P₂S₅ LiX | | | $\frac{[ {Li}_{2} S ]}{[ {Li}_{2} S ] + [ {P}_{2} {S}_{5} ]}$ | $\frac{[ {P}_{2} {S}_{5} ]}{[ L {i}_{2} S ] + [ {P}_{2} {S}_{5} ]}$ | $\frac{[ Li X ]}{[ {Li}_{2} S ] + [ {P}_{2} {S}_{5} ] + [ Li X ]}$ |
| Example 1 | 45 | 15 | 40 | 75 | 25 | 40 |
| Example 2 | 48.75 | 16.25 | 35 | 75 | 25 | 35 |
| Example 3 | 45 | 15 | 40 | 75 | 25 | 40 |
| Comp. Ex. 1 | 56.25 | 18.75 | 25 | 75 | 25 | 25 |
| Comp. Ex. 2 | 37.5 | 12.5 | 0 | 75 | 25 | 0 |
| Comp. Ex. 3 | 44.2 | 13.3 | 42.5 | 77 | 23 | 42.5 |
| Comp. Ex. 4 | 50.25 | 16.75 | 0 | 75 | 25 | 0 |

TABLE 4

| | Molar ratio to phosphorus (P) | | | | | |
|---|---|---|---|---|---|---|
| | Li | S | I | Br | C | BH₄ |
| Example 1 | 4.33 | 4.00 | 1.33 | 0.00 | 0.00 | 0.00 |
| Example 2 | 4.08 | 4.00 | 1.08 | 0.00 | 0.00 | 0.00 |
| Example 3 | 4.33 | 4.00 | 1.17 | 0.17 | 0.00 | 0.00 |
| Comp. Ex. 1 | 3.67 | 4.00 | 0.27 | 0.40 | 0.00 | 0.00 |
| Comp. Ex. 2 | 5.00 | 4.00 | 0.00 | 0.00 | 0.00 | 2.00 |
| Comp. Ex. 3 | 4.92 | 4.16 | 0.00 | 0.60 | 1.00 | 0.00 |
| Comp. Ex. 4 | 4.05 | 4.00 | 0.00 | 0.00 | 0.00 | 0.99 |

TABLE 5

| | | Ion conductivity | Ion resistance | Solid | | |
|---|---|---|---|---|---|---|
| | Properties of | of solid | of positive | electrolyte | Deterioration | Discharge |
| | solid | electrolyte | electrode mix | deterioration | of solid | capacity |
| | electrolyte | (mS/cm) | (Ωcm) | parameter Δ | electrolyte | (mAh/g) |
| Example 1 | Amorphous | 1.6 | 153 | 245 | None | 1527 |
| Example 2 | Amorphous | 2.0 | 190 | 380 | None | 1283 |
| Example 3 | Amorphous | 1.5 | 150 | 225 | None | 1722 |
| Comp. Ex. 1 | Crystalline | 5.2 | 157 | 816 | Present | 1067 |
| Comp. Ex. 2 | Crystalline | 5.3 | 1676 | 8883 | Present | 243 |
| Comp. Ex. 3 | Crystalline | 5.3 | 858 | 4547 | Present | 783 |
| Comp. Ex. 4 | Amorphous | 1.1 | 2464 | 2710 | Present | 696 |

From Tables 2 to 5, in the positive electrode mixture obtained by mechanically mixing the sulfide solid electrolyte produced in Examples 1 to 3 with the sulfur-based active material-conductive aid composite material, the deterioration of the solid electrolyte was suppressed. It is found that the all-solid-state lithium-ion battery containing the solid electrolyte as a positive electrode mixture is excellent in rate characteristics (discharge capacity).

On the other hand, in the positive electrode mixture containing the sulfide solid electrolyte of Comparative Examples 1 to 4, although the ion conductivity of the solid electrolyte is higher than that of Examples 1 to 3, the ion resistance of the positive electrode mixture is also higher than that of Examples 1 to 3, and thus the derived solid electrolyte deterioration parameter Δ is also high. When the positive electrode mixture of Comparative Examples 1 to 4 is a lithium-ion battery, the discharge capacity (rate characteristics) is lower than that of Examples 1 to 3. Therefore, in the positive electrode mixture of Comparative Examples 1 to 4, it is presumed that the solid electrolyte deteriorated by mechanical mixing.

### INDUSTRIAL APPLICABILITY

The positive electrode mixture of the present invention is suitable as a positive electrode of a lithium-ion battery. In addition, the lithium-ion battery of the present invention is suitably used for, for example, batteries used for information-related devices such as personal computers, video cameras, and mobile phones, communication devices, and vehicles such as electric vehicles.

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention. The documents described in the specification and the specification of Japanese application(s) on the basis of which the present application claims Paris convention priority are incorporated herein by reference in their entirety.

1. A positive electrode mixture comprising a sulfur-based active material and a sulfide solid electrolyte, wherein
the sulfide solid electrolyte comprises phosphorus (P) and halogen (X) including at least iodine (I) as constituent elements,
a molar ratio (X/P) of the halogen (X) to the phosphorus (P) is 0.86 or more, and
a molar ratio (I/P) of the iodine (I) to the phosphorus (P) is 0.10 or more.

2. The positive electrode mixture according to claim 1, wherein
the sulfide solid electrolyte comprises lithium (Li) as a constituent element, and
a molar ratio (Li/P) of the lithium (Li) to the phosphorus (P) is 2.00 or more.

3. The positive electrode mixture according to claim 1, wherein the sulfur-based active material comprises elemental sulfur or a discharge product thereof.

4. The positive electrode mixture according to claim 1, further comprising a conductive aid.

5. The positive electrode mixture according to claim 4, wherein the conductive aid is activated carbon.

6. The positive electrode mixture according to claim 1, wherein a solid electrolyte deterioration parameter Δ (Δ=α×β) calculated from an ion conductivity α of the sulfide solid electrolyte and an ion resistance β of the positive electrode mixture is less than 750.

7. A production method for a positive electrode mixture, comprising a step of mechanically mixing a sulfur-based active material and a sulfide solid electrolyte to form a composite, wherein
the sulfide solid electrolyte is synthesized from a mixed raw material comprising lithium (U), phosphorus (P), and halogen (X) including at least iodine (I), and
when it is assumed that the mixed raw material is a mixture of lithium sulfide (Li₂S), diphosphorus pentasulfide (P₂S₅), and lithium halide (LiX), the formulas (1) and (2) below are satisfied:
$$45 \leq [ {Li}_{2} S ] \times 100 / ( [ {Li}_{2} S ] + [ {P}_{2} {S}_{5} ] ) \leq 90 \qquad ( 1 )$$
$$30 \leq [ L i X ] \times 100 / ( [ L {i}_{2} S ] + [ {P}_{2} {S}_{5} ] + [ L i X ] ) \qquad ( 2 )$$
wherein the formulas, [Li₂S] is a molar ratio of Li₂S, [P₂S₅] is a molar ratio of P₂S₅, and [LiX] is a molar ratio of LiX.

8. The production method according to claim 7, wherein the mixed raw material is a mixture of lithium sulfide (Li₂S), diphosphorus pentasulfide (P₂S₅), and lithium halide (LiX).

9. The production method according to claim 7, wherein the formula (1) [Li₂S]×100/([Li₂S]+[P₂S₅]) is 74 or more and 76 or less.

10. The production method according to claim 7, wherein the sulfur-based active material comprises elemental sulfur or a discharge product thereof.

11. The production method according to claim 7, wherein a sulfur-based active material-conductive aid composite material is formed from the sulfur-based active material and the conductive aid, and then mechanically mixed with the sulfide solid electrolyte.

12. A positive electrode mixture obtained by the production method according to claim 7.

13. A positive electrode comprising the positive electrode mixture according to claim 1.

14. A lithium-ion battery comprising the positive electrode according to claim 13.
